(19) United States
(12) Patent Application Publication
(10) Pub. No.: US 2020/0004563 A1
(43) Pub. Date: Jan. 2, 2020

(54) DISPLAYING METHOD AND APPARATUS FOR NOTIFICATION BAR, ELECTRONIC DEVICE, AND STORAGE MEDIUM

(71) Applicant: BEIJING KINGSOFT INTERNET SECURITY SOFTWARE CO., LTD., Beijing (CN)

(72) Inventor: Meng-Chiao LIN, Beijing (CN)

(21) Appl. No.: 16/488,284

(22) PCT Filed: Apr. 19, 2018
(86) PCT No.: PCT/CN2018/083702

§ 371 Date: Aug. 23, 2019

(30) Foreign Application Priority Data
Jun. 30, 2017 (CN) 201710525649.9

(51) Int. Cl. G06F 9/451; G06F 3/0482; H04L 29/08

(52) U.S. Cl. CPC G06F 9/451; H04L 67/36; G06F 3/0482

(57) ABSTRACT

A displaying method and apparatus for a notification bar, electronic device and storage medium are provided. In the method, an enabling instruction for a first function is received, wherein the first function is at least one of reference functions preset to be displayed in a notification bar, the reference functions are functions determined at least based on a type of notification information and a type of a function shortcut button to be displayed in the notification bar; a current target function to be displayed is determined according to the enabling instruction, wherein the target function includes at least the first function; an identifier corresponding to the target function is displayed in the notification bar. Since the first function is at least one of reference functions to be displayed in the notification bar determined at least based on a type of notification information and a type of a function shortcut button to be displayed in the notification bar, only the function is displayed in the notification bar instead of specific notification information, which makes the notification bar concise so that users can find the function to be operated quickly.

The present application claims the priority to a Chinese patent application No. 201710525649.9 filed with the China National Intellectual Property Administration on Jun. 30, 2017 and entitled “Displaying Method and Apparatus for Notification Bar, Electronic Device and Storage Medium”, which is incorporated herein by reference in its entirety.

### TECHNICAL FIELD

The present application relates to the field of communication technologies, and in particular, to a displaying method and apparatus for a notification bar, electronic device and storage medium.

### BACKGROUND

At present, in a mobile terminal, notification information is displayed through a notification bar to prompt a user, or a function shortcut button is displayed through a notification bar so that a user can switch functions or access an application quickly through the function shortcut button. For example, when WeChat receives notification information, the notification information is displayed in the notification bar; or, a secure connection button is displayed in the notification bar and the network connection can be established or cut off through clicking the secure connection button by a user; or, a secure browsing button is displayed in the notification bar and an interface for browsing the application securely can be jumped to through clicking the secure browsing button by a user.

Due to an increasing number of applications in mobile terminals, functions of various applications are also increasing, resulting in that there may be a lot of notification information and function shortcut buttons in the notification bar simultaneously, which makes the notification bar disordered and makes it difficult for a user to find the function to be operated quickly.

Since information is displayed disorderly with existing displaying mode for a notification bar, there is an urgent need for a display mode for a notification bar to make the notification bar concise, such that a user can find the function to be operated quickly.

### SUMMARY

The objective of embodiments of the present application is to provide a displaying method and apparatus for a notification bar, an electronic device and a storage medium, which solve the problem of how to simplify the notification bar. The specific technical solutions are as follows.

In a first aspect, an embodiment of the present application provides a displaying method for a notification bar, which is applicable to an electronic device, and the method includes:

receiving an enabling instruction for a first function, wherein the first function is at least one of reference functions preset to be displayed in the notification bar, the reference functions are functions determined at least based on a type of notification information and a type of a function shortcut button to be displayed in the notification bar;

determining a current target function to be displayed according to the enabling instruction, wherein the target function includes at least the first function;

displaying an identifier corresponding to the target function in the notification bar.

Optionally, the step of determining a current target function to be displayed according to the enabling instruction includes:

determining the first function corresponding to the enabling instruction;

detecting whether there is a second function that is running;

if yes, determining the first function and the second function as current target functions to be displayed;

if not, determining the first function as the current target function to be displayed.

Optionally, the step of displaying an identifier corresponding to the target function in the notification bar includes:

displaying, by area, identifiers corresponding to target functions in the notification bar according to a number of the target functions and a type of each target function, wherein each area displays an identifier of one target function uniquely.

Optionally, the step of displaying, by area, identifiers corresponding to target functions in the notification bar according to a number of the target functions and a type of each target function includes:

detecting the type of each target function;

determining a first number of target functions with a type of function shortcut entrance;

detecting whether there is a target function that has received notification information among target functions with a type of communication information;

when there is a target function that has received notification information, determining a second number of target functions that have received notification information, dividing the notification bar into a third number of areas, and displaying an identifier of one target function in each area, wherein the third number equals to a sum of the first number and the second number;

when there is no target function that has received notification information, dividing the notification bar into the first number of areas, and displaying an identifier of one target function in each area.

Optionally, the step of displaying, by area, identifiers corresponding to target functions in the notification bar according to a number of the target functions and a type of each target function includes:

dividing the notification bar into a number of areas, wherein the number of the areas is the same as the number of the target functions;

detecting the type of each target function, and determining a fourth number of target functions with a type of function shortcut entrance;

detecting whether there is a target function that has received notification information among target functions with a type of communication information;

when there is a target function that has received notification information, determining a fifth number of target functions that have received notification information, selecting a sixth number of areas from the areas, and displaying an identifier of one target function in each area, wherein the sixth number equals to a sum of the fourth number and the fifth number;

when there is no target function that has received notification information, selecting the fourth number of areas from the areas, and displaying an identifier of one target function in each area.

Optionally, the target function includes at least one of secure connection, secure browsing, spam notification, and information security.

In a second aspect, an embodiment of the present application provides a displaying apparatus for a notification bar, which is applicable to an electronic device, and the apparatus includes:

a receiving module, configured for receiving an enabling instruction for a first function, wherein the first function is at least one of reference functions preset to be displayed in the notification bar, the reference functions are functions determined at least based on a type of notification information and a type of a function shortcut button to be displayed in the notification bar;

a determining module, configured for determining a current target function to be displayed according to the enabling instruction, wherein the target function includes at least the first function;

a display module, configured for displaying an identifier corresponding to the target function in the notification bar.

Optionally, the determining module includes:

a first function determining unit, configured for determining the first function corresponding to the enabling instruction;

a second function detecting unit, configured for detecting whether there is a second function that is running, if yes, triggering a first determining unit, and if not, triggering a second determining unit;

the first determining unit, configured for determining the first function and the second function as current target functions to be displayed;

the second determining unit, configured for determining the first function as the current target function to be displayed.

Optionally, the display module is further configured for:

displaying, by area, identifiers corresponding to target functions in the notification bar according to a number of the target functions and a type of each target function, wherein each area displays an identifier of one target function uniquely

Optionally, the display module includes:

a target type detecting unit, configured for detecting the type of each target function;

a first number determining unit, configured for determining a first number of target functions with a type of function shortcut entrance;

a first target function detecting unit, configured for, detecting whether there is a target function that has received notification information among target functions with a type of communication information, and if yes, triggering a first display unit, if not, triggering a second display unit;

the first display unit, configured for determining a second number of target functions that have received notification information, dividing the notification bar into a third number of areas, and displaying an identifier of one target function in each area, wherein the third number equals to a sum of the first number and the second number;

the second display unit, configured for dividing the notification bar into the first number of areas, and displaying an identifier of one target function in each area.

Optionally, the display module includes:

a dividing unit, configured for dividing the notification bar into a number of areas, wherein the number of the areas is the same as the number of the target functions;

a fourth number determining unit, configured for detecting the type of each target function, and determining a fourth number of target functions with a type of function shortcut entrance;

a second target function detecting unit, configured for, detecting whether there is a target function that has received notification information among target functions with a type of communication information, and if yes, triggering a third display unit, if not, triggering a fourth display unit;

the third display unit, configured for determining a fifth number of target functions that have received notification information, selecting a sixth number of areas from the areas, and displaying an identifier of one target function in each area, wherein the sixth number equals to a sum of the fourth number and the fifth number;

the fourth display unit, configured for selecting the fourth number of areas from the areas, and displaying an identifier of one target function in each area.

Optionally, the target function includes at least one of secure connection, secure browsing, spam notification, and information security.

In a third aspect, an embodiment of the present application provides an electronic device, including a processor, a communication interface, a memory, and a communication bus, wherein the processor, the communication interface, and the memory complete communication with each other through the communication bus.

The memory is configured for storing a computer program;

The processor is configured for implementing any of the methods described above when executing the program stored in the memory.

In a fourth aspect, an embodiment of the present application provides a computer readable storage medium, where the computer readable storage medium stores a computer program, and the computer program, when being executed by a processor, implements any of the methods described above.

In a fifth aspect, an embodiment of the present application provides an application program, where the application program is configured for performing any of the methods described above when being executed.

In the embodiments of the present application, an enabling instruction for a first function is received, wherein the first function is at least one of reference functions preset to be displayed in a notification bar, the reference functions are functions determined at least based on a type of notification information and a type of a function shortcut button to be displayed in the notification bar; a current target function to be displayed is determined according to the enabling instruction, wherein the target function includes at least the first function; an identifier corresponding to the target function is displayed in the notification bar. In the present application, an enabling instruction for the first function is received, a target function to be displayed is determined according to the enabling instruction, and an identifier corresponding to the target function is displayed in the notification bar after the target function is determined. Since the first function is at least one of reference functions determined at least based on a type of notification information and a type of a function shortcut button to be displayed in the notification bar, only the function is displayed in the notification bar instead of specific notification information, which makes the notification bar concise so that users can find the function to be operated quickly.

### BRIEF DESCRIPTION OF THE DRAWINGS

In order to more clearly describe the technical solution of the embodiments of the application and the prior art, drawings needed in the embodiments and the prior art will be briefly described below. Obviously, the drawings described below are for only some embodiments of the present application, one of ordinary skills in the art can also obtain other drawings based on these drawings without any creative efforts..

FIG. 1 is a schematic flowchart of a displaying method for a notification bar according to an embodiment of the present application;

FIG. 2 is a schematic diagram illustrating a notification bar in which an identifier corresponding to a secure connection function is displayed according to an embodiment of the present application;

FIG. 3 is a schematic flowchart of determining a current target function to be displayed according to an embodiment of the present application;

FIG. 4 is a first schematic flowchart of displaying, by area, an identifier corresponding to a target function in a notification bar according to an embodiment of the present application;

FIG. 5 is a schematic diagram illustrating a notification bar in which an identifier corresponding to a spam notification function is displayed according to an embodiment of the present application;

FIG. 6 is a schematic diagram illustrating a notification bar in which identifiers corresponding to a secure connection function, a spam notification function, and an information security function are displayed according to an embodiment of the present application;

FIG. 7 is a schematic diagram illustrating a notification bar in which identifiers corresponding to a secure connection function, a spam notification function, an information security function, and a security browsing function are displayed according to an embodiment of the present application;

FIG. 8 is a second schematic flowchart of displaying, by area, an identifier corresponding to a target function in a notification bar according to an embodiment of the present application;

FIG. 9 is a schematic structural diagram of a displaying apparatus for a notification bar according to an embodiment of the present application;

FIG. 10 is a schematic structural diagram of an electronic device according to an embodiment of the present application.

### DETAILED DESCRIPTION OF THE INVENTION

In order to make the objectives, technical solutions, and advantages of the present application more comprehensible, the present application will be further described in detail below by means of embodiments with reference to the accompanying drawings. It is apparent that the described embodiments are only a part of the embodiments of the present application, and not all of them. All other embodiments obtained by a person of ordinary skill in the art based on the embodiments of the present application without any creative effort fall within the protection scope of the present application.

In order to solve the problems in the prior art, embodiments of the present application provide a displaying method and apparatus for a notification bar, electronic device and storage medium.

A displaying method for a notification bar provided by an embodiment of the present application is first introduced.

It should be noted that the displaying method for a notification bar provided by the embodiment of the present application is applicable to an electronic device. In practical applications, the electronic device can be a smart phone, a tablet or the like, which is reasonable.

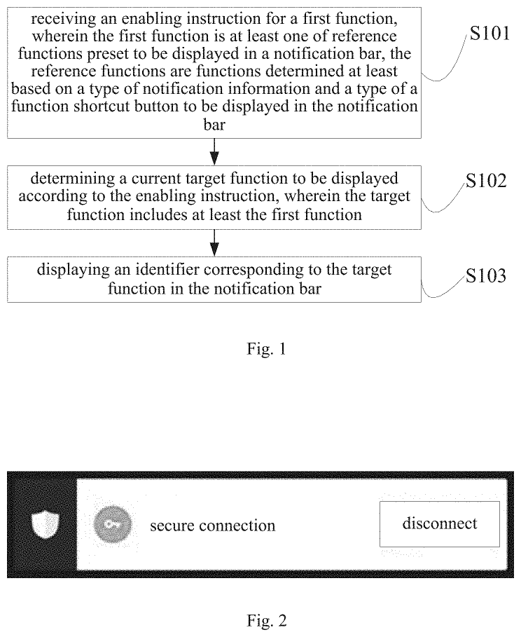

As shown in FIG. 1, the displaying method for a notification bar provided by the embodiment of the present application may include S101-S103.

S101, receiving an enabling instruction for a first function, wherein the first function is at least one of reference functions preset to be displayed in a notification bar, the reference functions are functions determined at least based on a type of notification information and a type of a function shortcut button to be displayed in the notification bar.

In order to enable a user to find the function to be operated from the notification bar quickly, in the embodiment of the present application, reference functions to be displayed in the notification bar are preset based at least on the type of notification information and a type of a function shortcut button to be displayed in the notification bar.

Since there are two kinds of notification information that is often received by the user: the notification information that is useful to the user, i.e. useful notification information, and the notification information that is useless to the use, i.e. useless notification information, the types of notification information displayed in the notification bar in general are useful and useless.

The display of the useful notification information in the notification bar is generally implemented by an information security function and the display of the useless notification information is generally implemented by a spam notification function. Therefore, it can be determined that the reference functions to be displayed in the notification bar include at least an information security function and a spam notification function based on the types of the notification information to be displayed in the notification bar.

Since the types of function shortcut buttons to be displayed in the notification bar are generally network connection and web browsing, based on the types of the function shortcut button to be displayed in the notification bar, it can be determined that the reference functions to be displayed in the notification bar include at least information security connection and secure browsing.

Obviously, the reference functions to be displayed in the notification bar are not limited to the above four types, and may include other functions.

After determining the reference functions to be displayed in the notification bar, when the user wants to display one or some functions in the notification bar, an enabling instruction for the first function is issued to enable the first function, the electronic device receives the enabling instruction for the first function.

S102, determining a current target function to be displayed according to the enabling instruction, wherein the target function includes at least the first function.

After receiving the enabling instruction, the current target function to be displayed is determined according to the enabling instruction.

The target function includes at least the first function, that is, at least one of secure connection, secure browsing, spam notification, and information security.

Secure connection means that after this function is enabled, the network connection can be automatically connected or disconnected after operations by the user. Secure browsing means that after this function is enabled, an interface for securely browsing an application can be jumped to after operations by the user. Spam notification means that after this function is enabled, when receiving useless notification information, it will automatically be classified as spam notification and displayed. Information security means that after this function is enabled, when useful notification information is received, the notification information will be automatically displayed.

S103, displaying an identifier corresponding to the target function in the notification bar.

After the current target function to be displayed is determined, the identifier corresponding to the target function can be displayed in the notification bar.

If there is only one target function determined, only one identifier is displayed in the notification bar, and if there are multiple target functions determined, multiple identifiers are displayed.

Thus, only the identifier corresponding to the function is displayed in the notification bar, that is, only the function is displayed instead of specific notification information, such that the user can find the function to be operated quickly. If the user wants to obtain the specific notification information, the user can click the identifier displayed in the notification bar corresponding to the target function. At this time, each piece of notification information contained in the target function is displayed, and the user can view each piece of notification information.

In the embodiment of the present application, an enabling instruction for a first function is received, wherein the first function is at least one of reference functions preset to be displayed in a notification bar, the reference functions are functions determined at least based on a type of notification information and a type of a function shortcut button to be displayed in the notification bar; a current target function to be displayed is determined according to the enabling instruction, wherein the target function includes at least the first function; an identifier corresponding to the target function is displayed in the notification bar. In the present application, an enabling instruction for the first function is received, a target function to be displayed is determined according to the enabling instruction, and an identifier corresponding to the target function is displayed in the notification bar after the target function is determined. Since the first function is at least one of reference functions determined at least based on the type of notification information and a type of a function shortcut button to be displayed in the notification bar, only the function is displayed in the notification bar instead of specific notification information, which makes the notification bar concise so that the user can find the function to be operated quickly.

The method shown in FIG. 1 will be described in detail below by means of a specific embodiment.

For example, the electronic device is a cell phone, and it is assumed that the first function is the secure connection function.

An enabling instruction for the secure connection function is received, the current target function to be displayed is determined to be the secure connection function according to the enabling instruction, the identifier corresponding to the secure connection function is displayed in the notification bar, as shown in FIG. 2. The identifier corresponding to the secure connection function is located on the left side of FIG. 2, and a disconnect button is located on the right side, network will be disconnected by clicking this button.

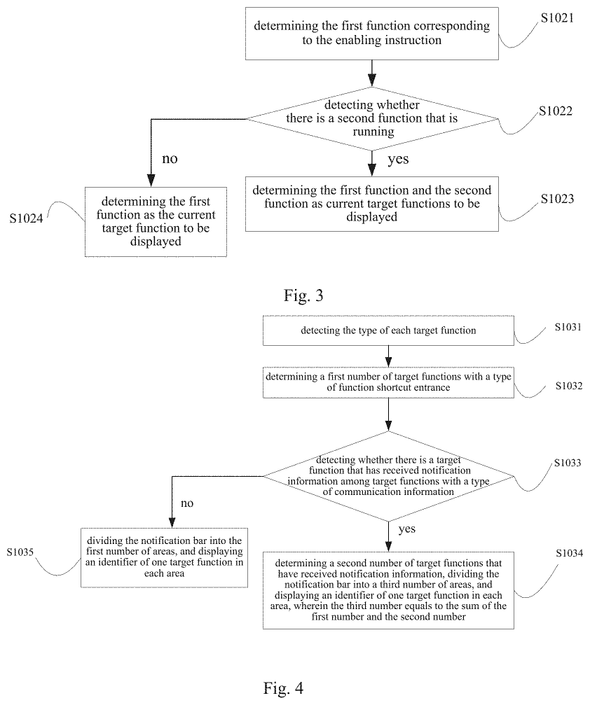

Further, determining a current target function to be displayed according to the enabling instruction may include detecting whether there is a function that is running, and determining the target function to be displayed based on the detection result. Referring to FIG. 3, S102 may include:

S1021, determining the first function corresponding to the enabling instruction.

S1022, detecting whether there is a second function that is running; if yes, executing step S1023; if not, executing step S1024.

S1023, determining the first function and the second function as current target functions to be displayed.

S1024, determining the first function as the current target function to be displayed. According to the enabling instruction, the first function corresponding to the enabling instruction is determined. After the first function corresponding to the enabling instruction is determined, it is necessary to know whether there is a function that is currently running, and therefore, whether there is a second function that is running is detected.

If there is a second function that is running, it indicates that the second function has been already running before the first function is enabled. Therefore, not only the first function but also the second function needs to be displayed in the notification bar. At this time, the first function and the second function are determined as the current target functions to be displayed. If there is no second function that is currently running, it indicates that there is no running function before the first function is enabled. At this time, the first function is determined as the current target function to be displayed.

Further, displaying an identifier corresponding to the target function in the notification bar may include:

displaying, by area, identifiers corresponding to target functions in the notification bar according to a number of the target functions and a type of each target function, wherein each area displays an identifier of one target function uniquely.

After current target functions to be displayed are determined, in order to display the determined target functions in the notification bar, it is necessary to determine the number of the target functions and the type of each target function.

After determining the number of the target functions and the type of each target function, the identifiers corresponding to the target functions are displayed in the notification bar by area, wherein each area displays an identifier of one target function uniquely.

Thus, the notification bar is concise and clear by means of display by area.

It can be understood that, there are various ways to display, by area, the identifiers corresponding to the target functions in the notification bar according to the number of the target functions and the type of each target function, which are described in detail below.

In an implementation of the present application, referring to FIG. 4, displaying, by area, identifiers corresponding to target functions in the notification bar according to a number of the target functions and a type of each target function may include:

S1031, detecting the type of each target function.

It can be known from step S101 that the types of functions to be displayed in the notification bar include at least four types: secure connection, secure browsing, spam notification, and information security. Secure connection and secure browsing are of a type of function shortcut entrance, and spam notification and information security are of a type of communication information. Therefore, the types of functions to be displayed in the notification bar are at least two types: the type of communication information and the type of function shortcut entrance.

Since each type of target function may be displayed differently when displayed, it is necessary to detect the type of each target function and perform corresponding steps based on the detection result.

S1032, determining a first number of target functions with a type of function shortcut entrance.

When target functions with the type of function shortcut entrance are detected, in order to display the target functions in the notification bar, it is necessary to obtain the first number of the target functions with the type of function shortcut entrance. Therefore, after target functions with the type of function shortcut entrance are detected, the first number of the target functions with the type of function shortcut entrance is determined.

It should be noted that when no target function with the type of function shortcut entrance is detected, it is not necessary to determine its number.

S1033, detecting whether there is a target function that has received notification information among target functions with a type of communication information, if yes, performing step S1034, if not, performing step S1035.

When target functions with the type of communication information are detected, it is necessary to detect whether there is a target function that has received notification information, and perform further steps according to the detection result.

S1034, determining a second number of target functions that have received notification information, dividing the notification bar into a third number of areas, and displaying an identifier of one target function in each area, wherein the third number equals to the sum of the first number and the second number.

When target functions that have received notification information are detected, it means that there is notification information to be viewed. In order to display the target functions that have received notification information in the notification bar, it is necessary to obtain the second number of target functions that have received notification information.

After the first number and the second number are determined, the sum of the first number and the second number is calculated, and the calculated sum is determined as a third number, which is the total number of target functions that need to be displayed in the notification bar.

In order to display each target function in the notification bar, the notification bar is divided into the third number of areas, and an identifier of one target function is displayed in each area. At the same time, the number of pieces of the notification information that has been received can be displayed in the area in which the target function that has received the notification information is located.

S1035, dividing the notification bar into the first number of areas, and displaying an identifier of one target function in each area.

When no target function that has received the notification information is detected, it means that there is no notification information that can be viewed. At this time, there is no need to display the target functions with the type of communication information in the notification bar. Therefore, the notification bar can be directly divided into the first number of areas, and an identifier of one target function is displayed in each area, that is, only the target functions with the type of function shortcut entrance are displayed in the notification bar.

Therefore, the type of each target function is detected first, and the number of target functions required to be displayed is further determined based on the detection result, and then the notification bar is divided into the same number of areas. After the areas are divided, i.e. the target functions are displayed in the areas, the space is saved because various target functions are displayed in one notification bar.

The method shown in FIG. 4 will be described in detail below by means of a specific embodiment.

For example, in a first case, it is assumed that the determined current target function to be displayed is the spam notification function.

The type of each target function is detected. Since only the spam notification function exists, only the target function with the type of communication information is detected, and no target function with the type of function shortcut entrance is detected, that is, the first number is 0.

For the detected target functions with the type of communication information (i.e., the spam notification function), it is detected whether there is a target function that has received the notification information. It is assumed that 16 pieces of spam notification information have been received, that is, it is detected that there is a target function that has received notification information.

The second number of target functions that have received the notification information is determined as 1, since the first number is 0 and the second number is 1, so the third number is 0+1=1.

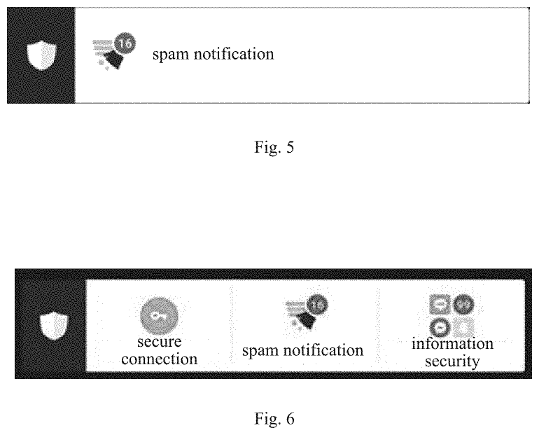

The notification bar is divided into the third number of areas, that is, the notification bar is divided into one area, and the identifier of the spam notification function is displayed in this area, as shown in FIG. 5. The number 16 in FIG. 5 indicates that 16 pieces of spam notification information have been received at this time.

In a second case, it is assumed that the first function is secure browsing. Referring to FIG. 6, before the first function is enabled, the functions that are currently running are secure connection, spam notification and information security. In FIG. 6, identifiers from left to right respectively are secure connection, spam notification, and information security, and at this time, 16 pieces of spam notification information and 99 pieces of notification information of information security have been received. The determined current target functions to be displayed are secure connection, spam notification, information security, and security browsing.

The type of each target function is detected. Due to the existence of secure connection function, spam notification function, information security function, and security browsing function, the target functions with the type of communication information are the spam notification function and the information security function, and the target functions with the type of function shortcut entrance are the secure connection function and the secure browsing function.

The first number of the target functions with the type of function shortcut entrance is 2.

For the target functions with the type of communication information, it is detected whether there is a target function that has received the notification information. Since 16 pieces of spam notification information and 99 pieces of notification information of information security have been received, it is determined that the second number of the target functions that have received notification information is 2.

Since the first number is 2 and the second number is 2, the third number is 2±2=4.

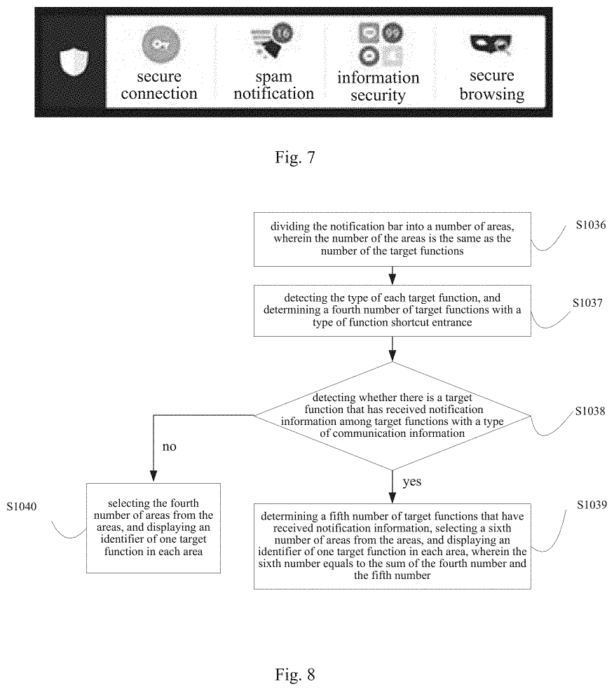

The notification bar is divided into the third number of areas, that is, the notification bar is divided into four areas, and the identifier of one target function is displayed in each area, as shown in FIG. 7. In FIG. 7, the target functions corresponding to the identifiers from left to right are respectively secure connection function, spam notification function, information security function and secure browsing function.

In another implementation of the present application, referring to FIG. 8, displaying, by area, identifiers corresponding to target functions in the notification bar according to a number of the target functions and a type of each target function may include:

S1036: dividing the notification bar into a number of areas, wherein the number of the areas is the same as the number of the target functions.

In order to display the target functions in the notification bar, it is necessary to determine the number of the target functions. After determining the number of the target functions, the notification bar can be divided into the same number of areas to display the target functions.

S1037: detecting the type of each target function, and determining a fourth number of target functions with a type of function shortcut entrance.

Since each type of the target functions may be displayed differently when displayed, for example, the target functions with the type of function shortcut entrance may be directly displayed in the notification bar, while the target functions with the type of communication information may be displayed in the notification bar only after receiving notification information. Therefore, after the notification bar is divided into the same number of areas, it is necessary to detect the type of each target function.

When target functions with the type of function shortcut entrance are detected, in order to display the target functions in the notification bar, it is necessary to obtain the fourth number of the target functions with the type of function shortcut entrance. Therefore, after the target functions with the type of function shortcut entrance are detected, the fourth number of the target functions with the type of function shortcut entrance is determined.

It should be noted that when no target function with the type of function shortcut entrance is detected, it is not necessary to determine its number.

S1038, detecting whether there is a target function that has received notification information among target functions with a type of communication information, if yes, performing step S1039, if not, performing step S1040.

When target functions with the type of communication information are detected, it is necessary to detect whether there is a target function that has received notification information, and perform further steps according to the detection result.

S1039, determining a fifth number of target functions that have received notification information, selecting a sixth number of areas from the areas, and displaying an identifier of one target function in each area, wherein the sixth number equals to the sum of the fourth number and the fifth number.

When target functions that have received notification information are detected, it means that there is notification information to be viewed. In order to display the target functions that have received notification information in the notification bar, it is necessary to obtain the fifth number of target functions that have received notification information.

After the fourth number and the fifth number are determined, the sum of the fourth number and the fifth number is calculated, and the calculated sum is determined as the sixth number, which is a total number of target functions that need to be displayed in the notification bar.

In order to display each target function in the notification bar, the sixth number of areas are selected from the areas, and an identifier of one target function is displayed in each area. At the same time, the number of pieces of the notification information that have been received can be displayed in the area in which the target function that has received the notification information is located.

S1040, selecting the fourth number of areas from the areas, and displaying an identifier of one target function in each area.

When no target function that has received the notification information is detected, it means that there is no notification information that can be viewed. At this time, there is no need to display the target functions with the type of communication information in the notification bar. Therefore, the fourth number of areas are selected form the areas, and an identifier of one target function is displayed in each area, that is, only the target functions with the type of function shortcut entrance are displayed in the notification bar.

Therefore, the number of target functions is detected first, the notification bar is divided into the same number of areas. Then the number of target functions that need to be displayed is determined, then the same number of areas is selected from the areas to display the target functions that need to be displayed. Since various target functions are displayed in one notification bar, space is saved. It should be noted that there may be blank areas in the notification bar in this implementation.

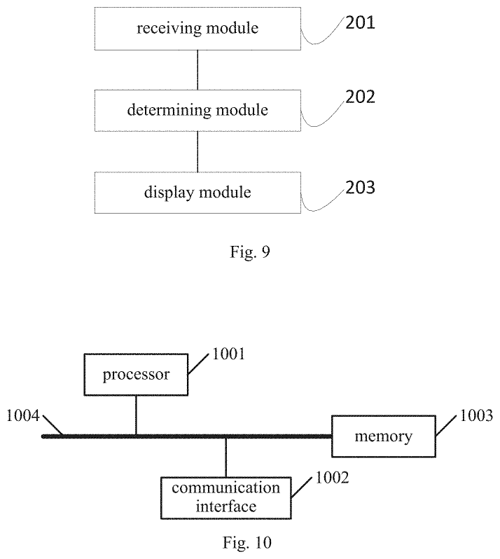

Corresponding to the above method embodiment, as shown in FIG. 9, an embodiment of the present application further provides a displaying apparatus for a notification bar, the apparatus includes:

a receiving module 201, configured for receiving an enabling instruction for a first function, wherein the first function is at least one of reference functions preset to be displayed in a notification bar, the reference functions are functions determined at least based on a type of notification information and a type of a function shortcut button to be displayed in the notification bar;

a determining module 202, configured for determining a current target function to be displayed according to the enabling instruction, wherein the target function includes at least the first function;

a display module 203, configured for displaying an identifier corresponding to the target function in the notification bar.

In the embodiment of the present application, an enabling instruction for a first function is received, wherein the first function is at least one of reference functions preset to be displayed in a notification bar, the reference functions are functions determined at least based on a type of notification information and a type of a function shortcut button to be displayed in the notification bar; a current target function to be displayed is determined according to the enabling instruction, wherein the target function includes at least the first function; an identifier corresponding to the target function is displayed in the notification bar. In the present application, an enabling instruction for the first function is received, a target function to be displayed is determined according to the enabling instruction, and an identifier corresponding to the target function is displayed in the notification bar after the target function is determined. Since the first function is at least one of reference functions determined at least based on a type of notification information and a type of a function shortcut button to be displayed in the notification bar, only the function is displayed in the notification bar instead of specific notification information, which makes the notification bar concise so that users can find the function to be operated quickly.

In an implementation of the present application, the determining module 202 may include:

a first function determining unit, configured for determining the first function corresponding to the enabling instruction;

a second function detecting unit, configured for detecting whether there is a second function that is running, if yes, triggering a first determining unit, and if not, triggering a second determining unit;

the first determining unit, configured for determining the first function and the second function as current target functions to be displayed;

the second determining unit, configured for determining the first function as the current target function to be displayed.

In an implementation of the present application, the display module 203 may be specifically configured for:

displaying, by area, identifiers corresponding to target functions in the notification bar according to a number of the target functions and a type of each target function, wherein each area displays an identifier of one target function uniquely.

In an implementation of the present application, the display module 203 may include:

a target type detecting unit, configured for detecting the type of each target function;

a first number determining unit, configured for determining a first number of target functions with a type of function shortcut entrance;

a first target function detecting unit, configured for, detecting whether there is a target function that has received notification information among target functions with a type of communication information, and if yes, triggering a first display unit, if not, triggering a second display unit;

the first display unit, configured for determining a second number of target functions that have received notification information, dividing the notification bar into a third number of areas, and displaying an identifier of one target function in each area, wherein the third number equals to the sum of the first number and the second number;

the second display unit, configured for dividing the notification bar into the first number of areas, and displaying an identifier of one target function in each area.

In an implementation of the present application, the display module 203 may include:

a dividing unit, configured for dividing the notification bar into a number of areas, wherein the number of the areas is the same as the number of the target functions;

a fourth number determining unit, configured for detecting the type of each target function, and determining a fourth number of target functions with a type of function shortcut entrance;

a second target function detecting unit, configured for, detecting whether there is a target function that has received notification information among target functions with a type of communication information, and if yes, triggering a third display unit, if not, triggering a fourth display unit;

the third display unit, configured for determining a fifth number of target functions that have received notification information, selecting a sixth number of areas from the areas, and displaying an identifier of one target function in each area, wherein the sixth number equals to the sum of the fourth number and the fifth number;

the fourth display unit, configured for selecting the fourth number of areas from the areas, and displaying an identifier of one target function in each area.

In an implementation of the present application, the target function includes at least one of secure connection, secure browsing, spam notification, and information security.

An embodiment of the present application further provides an electronic device, as shown in FIG. 10, including a processor 1001, a communication interface 1002, a memory 1003, and a communication bus 1004, wherein the processor 1001, the communication interface 1002 and the memory 1003 complete communication with each other through the communication bus 1004.

The memory 1003 is configured for storing a computer program.

The processor 1001, when executing the program stored in the memory 1003, implements the following steps:

receiving an enabling instruction for a first function, wherein the first function is at least one of reference functions preset to be displayed in a notification bar, the reference functions are functions determined at least based on a type of notification information and a type of a function shortcut button to be displayed in the notification bar;

determining a current target function to be displayed according to the enabling instruction, wherein the target function includes at least the first function;

displaying an identifier corresponding to the target function in the notification bar.

In the embodiment of the present application, an enabling instruction for a first function is received, wherein the first function is at least one of reference functions preset to be displayed in a notification bar, the reference functions are functions determined at least based on a type of notification information and a type of a function shortcut button to be displayed in the notification bar; a current target function to be displayed is determined according to the enabling instruction, wherein the target function includes at least the first function; an identifier corresponding to the target function is displayed in the notification bar. In the present application, an enabling instruction for the first function is received, a target function to be displayed is determined according to the enabling instruction, and an identifier corresponding to the target function is displayed in the notification bar after the target function is determined. Since the first function is at least one of reference functions determined at least based on a type of notification information and a type of a function shortcut button to be displayed in the notification bar, only the function is displayed in the notification bar instead of specific notification information, which makes the notification bar concise so that users can find the function to be operated quickly.

In an implementation of the present application, the step of determining the current target function to be displayed according to the enabling instruction may include:

determining the first function corresponding to the enabling instruction;

detecting whether there is a second function that is running;

if yes, determining the first function and the second function as current target functions to be displayed;

if not, determining the first function as the current target function to be displayed.

In an implementation of the present application, the step of displaying an identifier corresponding to the target function in the notification bar may include:

displaying, by area, identifiers corresponding to target functions in the notification bar according to a number of the target functions and a type of each target function, wherein each area displays an identifier of one target function uniquely.

In an implementation of the present application, the step of displaying, by area, identifiers corresponding to target functions in the notification bar according to a number of the target functions and a type of each target function may include:

detecting the type of each target function;

determining a first number of target functions with a type of function shortcut entrance;

detecting whether there is a target function that has received notification information among target functions with a type of communication information;

when there is a target function that has received notification information, determining a second number of target functions that have received notification information, dividing the notification bar into a third number of areas, and displaying an identifier of one target function in each area, wherein the third number equals to the sum of the first number and the second number;

when there is no target function that has received notification information, dividing the notification bar into the first number of areas, and displaying an identifier of one target function in each area.

In an implementation of the present application, the step of displaying, by area, identifiers corresponding to target functions in the notification bar according to a number of the target functions and a type of each target function may include:

dividing the notification bar into a number of areas, wherein the number of the areas is the same as the number of the target functions;

detecting the type of each target function, and determining a fourth number of target functions with a type of function shortcut entrance;

detecting whether there is a target function that has received notification information among target functions with a type of communication information;

when there is a target function that has received notification information, determining a fifth number of target functions that have received notification information, selecting a sixth number of areas from the areas, and displaying an identifier of one target function in each area, wherein the sixth number equals to the sum of the fourth number and the fifth number;

when there is no target function that has received notification information, selecting the fourth number of areas from the areas, and displaying an identifier of one target function in each area.

In an implementation of the present application, the target function includes at least one of secure connection, secure browsing, spam notification, and information security.

The communication bus mentioned in the above electronic device may be a Peripheral Component Interconnect (PCI) bus or an Extended industry Standard Architecture (EISA) bus. The communication bus can be classified into an address bus, a data bus, a control bus, and the like. For convenience of representation, only one thick line is shown in the figures, but it does not mean that there is only one bus or one type of bus.

The communication interface is configured for communication between the above electronic device and other apparatuses.

The memory may include a random access memory (RAM), and may also include a non-volatile memory (NVM), such as at least one disk storage. Optionally, the memory may also be at least one storage device located away from the aforementioned processor.

The above processor may be a general-purpose processor, including a Central Processing Unit (CPU), a Network Processor (NP), and the like; or may be a Digital Signal Processing (DSP), an Application Specific Integrated Circuit (ASIC), a Field-Programmable Gate Array (FPGA) or other programmable logic devices, discrete gates or transistor logic devices, discrete hardware components.

An embodiment of the present application further provides a computer readable storage medium, where the computer readable storage medium stores a computer program, and the computer program, when being executed by a processor, implements the following steps:

receiving an enabling instruction for a first function, wherein the first function is at least one of reference functions preset to be displayed in a notification bar, the reference functions are functions determined at least based on a type of notification information and a type of a function shortcut button to be displayed in the notification bar;

determining a current target function to be displayed according to the enabling instruction, wherein the target function includes at least the first function;

displaying an identifier corresponding to the target function in the notification bar.

In the embodiment of the present application, an enabling instruction for a first function is received, wherein the first function is at least one of reference functions preset to be displayed in a notification bar, the reference functions are functions determined at least based on a type of notification information and a type of a function shortcut button to be displayed in the notification bar; a current target function to be displayed is determined according to the enabling instruction, wherein the target function includes at least the first function; an identifier corresponding to the target function is displayed in the notification bar. In the present application, an enabling instruction for the first function is received, a target function to be displayed is determined according to the enabling instruction, and an identifier corresponding to the target function is displayed in the notification bar after the target function is determined. Since the first function is at least one of reference functions determined at least based on a type of notification information and a type of a function shortcut button to be displayed in the notification bar, only the function is displayed in the notification bar instead of specific notification information, which makes the notification bar concise so that users can find the function to be operated quickly.

In an implementation of the present application, the step of determining a target function to be displayed according to the enabling instruction may include:

determining the first function corresponding to the enabling instruction;

detecting whether there is a second function that is running;

if yes, determining the first function and the second function as current target functions to be displayed;

if not, determining the first function as the current target function to be displayed.

In an implementation of the present application, the step of displaying an identifier corresponding to the target function in the notification bar may include:

displaying, by area, identifiers corresponding to target functions in the notification bar according to a number of the target functions and a type of each target function, wherein each area displays an identifier of one target function uniquely.

In an implementation of the present application, the step of displaying, by area, identifiers corresponding to target functions in the notification bar according to a number of the target functions and a type of each target function may include:

detecting the type of each target function;

determining a first number of target functions with a type of function shortcut entrance;

detecting whether there is a target function that has received notification information among target functions with a type of communication information;

when there is a target function that has received notification information, determining a second number of target functions that have received notification information, dividing the notification bar into a third number of areas, and displaying an identifier of one target function in each area, wherein the third number equals to the sum of the first number and the second number;

when there is no target function that has received notification information, dividing the notification bar into the first number of areas, and displaying an identifier of one target function in each area.

In an implementation of the present application, the step of displaying, by area, identifiers corresponding to target functions in the notification bar according to a number of the target functions and a type of each target function may include:

dividing the notification bar into a number of areas, wherein the number of the areas is the same as the number of the target functions;

detecting the type of each target function, and determining a fourth number of target functions with a type of function shortcut entrance;

detecting whether there is a target function that has received notification information among target functions with a type of communication information;

when there is a target function that has received notification information, determining a fifth number of target functions that have received notification information, selecting a sixth number of areas from the areas, and displaying an identifier of one target function in each area, wherein the sixth number equals to the sum of the fourth number and the fifth number;

when there is no target function that has received notification information, selecting the fourth number of areas from the areas, and displaying an identifier of one target function in each area.

In an implementation of the present application, the target function includes at least one of secure connection, secure browsing, spam notification, and information security.

An embodiment of the present application further provides an application program, where the application program is configured for performing the following steps when executed:

receiving an enabling instruction for a first function, wherein the first function is at least one of reference functions preset to be displayed in a notification bar, the reference functions are functions determined at least based on a type of notification information and a type of a function shortcut button to be displayed in the notification bar;

determining a current target function to be displayed according to the enabling instruction, wherein the target function includes at least the first function;

displaying an identifier corresponding to the target function in the notification bar.

In the embodiment of the present application, an enabling instruction for a first function is received, wherein the first function is at least one of reference functions preset to be displayed in a notification bar, the reference functions are functions determined at least based on a type of notification information and a type of a function shortcut button to be displayed in the notification bar; a current target function to be displayed is determined according to the enabling instruction, wherein the target function includes at least the first function; an identifier corresponding to the target function is displayed in the notification bar. In the present application, an enabling instruction for the first function is received, a target function to be displayed is determined according to the enabling instruction, and an identifier corresponding to the target function is displayed in the notification bar after the target function is determined. Since the first function is at least one of reference functions determined at least based on the type of notification information and a type of a function shortcut button to be displayed in the notification bar, only the function is displayed in the notification bar instead of specific notification information, which makes the notification bar concise so that users can find the function to be operated quickly.

In an implementation of the present application, the step of determining a current target function to be displayed according to the enabling instruction may include:

determining the first function corresponding to the enabling instruction;

detecting whether there is a second function that is running;

if yes, determining the first function and the second function as current target functions to be displayed;

if not, determining the first function as the current target function to be displayed.

In an implementation of the present application, the step of displaying an identifier corresponding to the target function in the notification bar may include:

displaying, by area, identifiers corresponding to target functions in the notification bar according to a number of the target functions and a type of each target function, wherein each area displays an identifier of one target function uniquely.

In an implementation of the present application, the step of displaying, by area, identifiers corresponding to target functions in the notification bar according to a number of the target functions and a type of each target function may include:

detecting the type of each target function;

determining a first number of target functions with a type of function shortcut entrance;

detecting whether there is a target function that has received notification information among target functions with a type of communication information;

when there is a target function that has received notification information, determining a second number of target functions that have received notification information, dividing the notification bar into a third number of areas, and displaying an identifier of one target function in each area, wherein the third number equals to the sum of the first number and the second number;

when there is no target function that has received notification information, dividing the notification bar into the first number of areas, and displaying an identifier of one target function in each area.

In an implementation of the present application, the step of displaying, by area, identifiers corresponding to target functions in the notification bar according to a number of the target functions and a type of each target function may include:

dividing the notification bar into a number of areas, wherein the number of the areas is the same as the number of the target functions;

detecting the type of each target function, and determining a fourth number of target functions with a type of function shortcut entrance;

detecting whether there is a target function that has received notification information among target functions with a type of communication information;

when there is a target function that has received notification information, determining a fifth number of target functions that have received notification information, selecting a sixth number of areas from the areas, and displaying an identifier of one target function in each area, wherein the sixth number equals to the sum of the fourth number and the fifth number;

when there is no target function that has received notification information, selecting the fourth number of areas from the areas, and displaying an identifier of one target function in each area.

In an implementation of the present application, the target function includes at least one of secure connection, secure browsing, spam notification, and information security.

For the embodiments of the apparatus, the electronic device, the storage medium and the application program, since they are basically similar to the method embodiments, the description is relatively simple, and the relevant parts can be referred to the description of the method embodiments.

The terms used in the embodiments of the present application are for the purpose of describing particular embodiments only, and are not intended to limit the application. The singular forms “a”, “the”, and “this” used in the embodiments and attached claims are intended to include plural form, unless other meanings are specified in the context. It should also be understood that the term “and/or” as used herein refers to and encompasses any and all possible combinations of one or more associated listed items.

It should be understood that although the terms “first”, “second”, “third”, and the like may be used to describe various connection interfaces and identification information in the embodiments of the present application, these connection interfaces and identification information and the like should not be limited to these terms. These terms are only used to distinguish one connection interface and identification information and the like from another. For example, a first connection interface may also he referred to as a second connection interface without departing from the scope of the embodiments of the present application. Similarly, a second connection interface may also be referred to as a first connection interface.

Depending on the context, the word “if” as used herein may be interpreted as “at the time when” or “when” or “in response to determining” or “in response to detecting.” Similarly, depending on the context, the phrase “if it is determined that” or “if it is detected that (conditions or events stated)” may be interpreted as “when it is determined that” or “in response to determining” or “when it is detected that (conditions or events stated) ” or “in response to detecting (conditions or events stated)”.

Through the description of the above embodiments, those skilled in the art can clearly understand that for the convenience and brevity of the description, the division of the above functional modules is only illustrated. In practical applications, the above functions can be allocated to and implemented by various functional modules according to needs. That is, the internal structure of the device is divided into different functional modules to implement all or part of the functions described above. For the specific working process of the system, the device and the unit described above, reference may be made to the corresponding process in the foregoing method embodiments, and details are not described herein again.

In the several embodiments provided by the present application, it should be understood that the disclosed system, apparatus, and method may be implemented in other manners. For example, the apparatus embodiments described above are merely illustrative. For example, the division of modules or units is only a logical function division. In actual implementations, there may be another division manner, for example, multiple units or components may be combined or may be integrated into another system, or some features can be ignored or not executed. In addition, the mutual coupling or direct coupling or communication connection shown or discussed may be an indirect coupling or communication connection through some interfaces, devices or units, and may be in an electrical, mechanical or other form.

The units described as separate components may or may not be physically separated, and the components illustrated as units may or may not be physical units, that is, may be located in one place, or may be distributed to multiple network units. Some or all of the units may be selected to achieve the solution of the embodiment according to actual needs.

In addition, various functional units in various embodiments of the present application may be integrated into one processing unit, or each unit may exist physically separately, or two or more units may be integrated into one unit. The above integrated unit can be implemented in the form of hardware or in the form of a software functional unit.

The integrated unit, if implemented in the form of a software functional unit and sold or used as an independent product, may be stored in a computer readable storage medium. Based on such understanding, the technical solution of the present application in essence or the part that contributes to the prior art, or all or part of the technical solution may be embodied in the form of a computer software product. The computer software product is stored in a storage medium, and includes a number of instructions to cause a computer device (which may be a personal computer, server, or network apparatus, etc.) or a processor to perform all or part of the steps of the methods described in various embodiments of the present application. The foregoing storage medium includes medium in which the program code is stored, such as a U disk, a mobile hard disk, a read only memory (hereinafter referred to as RUM), a random access memory (hereinafter referred to as RAM), a magnetic disk, or an optical disk.

The above description is only for the preferred embodiments of the present application, and is not intended to limit the present application. Any modifications, equivalent substitutions, improvements, and the like, which are made within the spirit and principles of the present application, should fall within the protection scope of the present application.

1. A displaying method for a notification bar, which is applicable to an electronic device, comprising:
receiving an enabling instruction for a first function, wherein the first function is at least one of reference functions preset to be displayed in the notification bar, the reference functions are functions determined at least based on a type of notification information and a type of a function shortcut button to be displayed in the notification bar;
determining a current target function to be displayed according to the enabling instruction, wherein the target function comprises at least the first function;
displaying an identifier corresponding to the target function in the notification bar.

2. The method according to claim 1, wherein, the step of determining a current target function to be displayed according to the enabling instruction comprises:
determining the first function corresponding to the enabling instruction;
detecting whether there is a second function that is running;
if yes, determining the first function and the second function as current target functions to be displayed;
if not, determining the first function as the current target function to be displayed.

3. The method according to claim 1, wherein, the step of displaying an identifier corresponding to the target function in the notification bar comprises:
displaying, by area, identifiers corresponding to target functions in the notification bar according to a number of the target functions and a type of each target function, wherein each area displays an identifier of one target function uniquely.

4. The method according to claim 3, wherein, the step of displaying, by area, identifiers corresponding to target functions in the notification bar according to a number of the target functions and a type of each target function comprises:
detecting the type of each target function;
determining a first number of target functions with a type of function shortcut entrance;
detecting whether there is a target function that has received notification information among target functions with a type of communication information;
when there is a target function that has received notification information, determining a second number of target functions that have received notification information, dividing the notification bar into a third number of areas, and displaying an identifier of one target function in each area, wherein the third number equals to a sum of the first number and the second number;
when there is no target function that has received notification information, dividing the notification bar into the first number of areas, and displaying an identifier of one target function in each area.

5. The method according to claim 3, wherein, the step of displaying, by area, identifiers corresponding to target functions in the notification bar according to a number of the target functions and a type of each target function comprises:
dividing the notification bar into a number of areas, wherein the number of the areas is the same as the number of the target functions;
detecting the type of each target function, and determining a fourth number of target functions with a type of function shortcut entrance;
detecting whether there is a target function that has received notification information among target functions with a type of communication information;
when there is a target function that has received notification information, determining a fifth number of target functions that have received notification information, selecting a sixth number of areas from the areas, and displaying an identifier of one target function in each area, wherein the sixth number equals to a sum of the fourth number and the fifth number;
when there is no target function that has received notification information, selecting the fourth number of areas from the areas, and displaying an identifier of one target function in each area.

6. The method according to claim 1, wherein, the target function comprises at least one of secure connection, secure browsing, spam notification, and information security.

7-12. (canceled)

13. An electronic device, comprising a processor, a communication interface, a memory, and a communication bus, wherein the processor, the communication interface, and the memory complete communication with each other through the communication bus;
the memory is configured for storing a computer program;
the processor is configured for, when executing the program stored in the memory, implementing a process comprising:
receiving an enabling instruction for a first function, wherein the first function is at least one of reference functions preset to be displayed in the notification bar, the reference functions are functions determined at least based on a type of notification information and a type of a function shortcut button to be displayed in the notification bar;
determining a current target function to be displayed according to the enabling instruction, wherein the target function comprises at least the first function;
displaying an identifier corresponding to the target function in the notification bar.

14. A non-transitory computer readable storage medium, which stores a computer program, wherein the computer program implements the method according to claim 1 when being executed by a processor.

15. (canceled)

16. The electronic device according to claim 13, wherein, determining a current target function to be displayed according to the enabling instruction comprises:
determining the first function corresponding to the enabling instruction;
detecting whether there is a second function that is running;
if yes, determining the first function and the second function as current target functions to be displayed;
if not, determining the first function as the current target function to be displayed.

17. The electronic device according to claim 13, wherein, displaying an identifier corresponding to the target function in the notification bar comprises:
displaying, by area, identifiers corresponding to target functions in the notification bar according to a number of the target functions and a type of each target function, wherein each area displays an identifier of one target function uniquely.

18. The electronic device according to claim 17, wherein, displaying, by area, identifiers corresponding to target functions in the notification bar according to a number of the target functions and a type of each target function comprises:
detecting the type of each target function;
determining a first number of target functions with a type of function shortcut entrance;
detecting whether there is a target function that has received notification information among target functions with a type of communication information;
when there is a target function that has received notification information, determining a second number of target functions that have received notification information, dividing the notification bar into a third number of areas, and displaying an identifier of one target function in each area, wherein the third number equals to a sum of the first number and the second number;
when there is no target function that has received notification information, dividing the notification bar into the first number of areas, and displaying an identifier of one target function in each area.

19. The electronic device according to claim 17, wherein, displaying, by area, identifiers corresponding to target functions in the notification bar according to a number of the target functions and a type of each target function comprises:
dividing the notification bar into a number of areas, wherein the number of the areas is the same as the number of the target functions;
detecting the type of each target function, and determining a fourth number of target functions with a type of function shortcut entrance;
detecting whether there is a target function that has received notification information among target functions with a type of communication information;
when there is a target function that has received notification information, determining a fifth number of target functions that have received notification information, selecting a sixth number of areas from the areas, and displaying an identifier of one target function in each area, wherein the sixth number equals to a sum of the fourth number and the fifth number;
when there is no target function that has received notification information, selecting the fourth number of areas from the areas, and displaying an identifier of one target function in each area.

20. The electronic device according to claim 13, wherein, the target function comprises at least one of secure connection, secure browsing, spam notification, and information security.
